(19) United States
(12) Patent Application Publication
(10) Pub. No.: US 2026/0228803 A1
(43) Pub. Date: Aug. 6, 2026

(54) CROSS-DOMAIN USER ACTION PREDICTION USING MACHINE LEARNING MODELS

(71) Applicant: Maplebear Inc., San Francisco, CA (US)

(72) Inventors: Prithvishankar Srinivasan, Seattle, WA (US); Shishir Kumar Prasad, San Ramon, CA (US); Danna Weintraub, San Francisco, CA (US); Deepak Dilipkumar, New York, NY (US); Ahsaas Bajaj, Jersey City, NJ (US)

(21) Appl. No.: 19/042,016

(22) Filed: Jan. 31, 2025

(51) Int. Cl. G06Q 30/0601; G06Q 50/12

(52) U.S. Cl. CPC G06Q 30/0641; G06Q 30/0631; G06Q 50/12

(57) ABSTRACT

An online system receives a request from a client device associated with a user to access a user interface for placing an order and retrieves user data for the user, in which the user data describe a first set of actions in a first domain performed by the user. The system accesses and applies a machine-learning model to predict a score for each of multiple candidate restaurants based on the user data and restaurant data for the candidate restaurant, in which the score indicates a likelihood of a second set of actions in a second domain performed by the user if presented with a recommendation associated with a restaurant. The system selects a set of restaurants from the candidate restaurants based on the scores, generates the user interface including a set of recommendations associated with the set of restaurants, and sends the user interface to the client device.

### BACKGROUND

Online systems often enable users to place orders fulfilled by pickers who retrieve items from various sources, such as grocery stores or restaurants, and deliver them to the users. These systems may recommend sources or restaurants based on the users'preferences for specific types of items. However, user preferences for items in different domains—such as grocery shopping and restaurant dining—may vary significantly. For example, a recommendation for a pizzeria may be well-suited for a first user who frequently orders both frozen pizza from a grocery store and prepared pizza from a restaurant, but the same recommendation may not be useful for a second user who prefers making pizza from scratch and rarely orders pizza from a restaurant.

User preferences across these domains can be highly nuanced and complex, influenced by factors such as availability of ingredients, personal cooking habits, and willingness to try new foods. For example, if the second user recently searched for pizza ingredients but found some items unavailable, they may be more likely to order from a pizzeria. Conversely, a user who enjoys exploring new cuisines may not order from a Thai restaurant after purchasing Thai food ingredients from a grocery store, while another user who consistently orders Thai food may be more inclined to do so regardless of recent grocery purchases.

These intricate patterns are not only difficult to understand but also present significant challenges for online systems attempting to generate accurate and personalized recommendations. Traditional systems that rely on single-domain data (e.g., grocery shopping behavior alone or restaurant interactions alone) often fail to account for the cross-domain relationships that influence user decisions.

Hence, a technical problem lies in designing a system capable of integrating and analyzing heterogeneous user behavior data from distinct domains (e.g., grocery shopping and restaurant interactions) to generate accurate and contextually-relevant recommendations. Existing systems do not adequately leverage cross-domain signals to uncover the complex relationships between grocery purchasing behavior and restaurant dining preferences.

### SUMMARY

To address these technical problems, one or more embodiments use machine learning models that process cross-domain user behavior data, such as grocery shopping habits and restaurant preferences. By leveraging advanced feature engineering, cohort classification, and dynamic recommendation algorithms, one or more embodiments can generate personalized and contextually appropriate recommendations, thereby improving user engagement and overall system performance.

In accordance with one or more aspects of the disclosure, an online system predicts user actions in a domain based on user actions in another domain using machine learning. More specifically, an online system receives a request from a client device associated with a user of the online system to access a user interface for placing an order from a source or a restaurant. The online system then retrieves a set of user data for the user, in which the set of user data includes information describing a first set of actions in a first domain performed by the user and the first domain is associated with one or more sources. The online system then accesses a machine-learning model trained to predict a restaurant action score indicating a likelihood of a second set of actions in a second domain performed by the user if presented with a recommendation associated with a restaurant, in which the second domain is associated with one or more restaurants. For each of multiple candidate restaurants, the online system applies the model to predict the score based on the set of user data and a set of restaurant data for the candidate restaurant. The online system then selects a set of restaurants from the candidate restaurants based on the scores, generates the user interface including a set of recommendations associated with the set of restaurants, and sends the user interface to the client device, causing it to display the user interface. In one or more embodiments, the online system applies the model to predict the score based on order data for a set of orders the user placed within a threshold amount of time of a current time, while in other embodiments, the online system applies the model to predict the score based on a set of contextual information associated with the user. The machine learning model may use embeddings to represent users, items, restaurants, and sources, allowing the system to capture complex relationships between these entities.

In some embodiments, the online system may access an additional machine-learning model trained to predict a source action score indicating an additional likelihood of a set of actions in the first domain performed by the user if presented with a recommendation associated with a source. In such embodiments, for each of multiple candidate sources, the online system applies the model to predict the source action score based on the set of user data and a set of source data for the candidate source, in which the set of user data also includes information describing an additional set of actions in the second domain performed by the user. The online system may then rank the candidate restaurants and candidate sources in a unified ranking based on the restaurant action scores and the source action scores and select the set of restaurants and a set of sources based on the unified ranking. Such unified ranking may allow for a more holistic and personalized user experience by considering preferences across multiple domains.

Thus, by using a machine-learning model to predict a restaurant action score or a source action score, the online system may uncover complex patterns or concepts that are difficult or impossible for a human mind to understand that affect the likelihood that a user will perform a set of actions associated with a restaurant or a source. Furthermore, by predicting the restaurant action score or the source action score based on order data for orders the user recently placed or contextual information associated with the user (e.g., a day of the week, a holiday, items in an ordering list associated with the user, etc.), the online system may account for the added complexity such factors may contribute. In this way, the use of machine learning models allows the system to adapt to evolving user preferences and contextual factors, leading to more accurate and timely recommendations.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for predicting user actions in a domain based on user actions in another domain using machine learning, in accordance with one or more embodiments.

FIGS. 4A-4B illustrate examples of a user interface including a set of recommendations associated with a set of restaurants selected based on a restaurant action score, in accordance with one or more embodiments.

### DETAILED DESCRIPTION

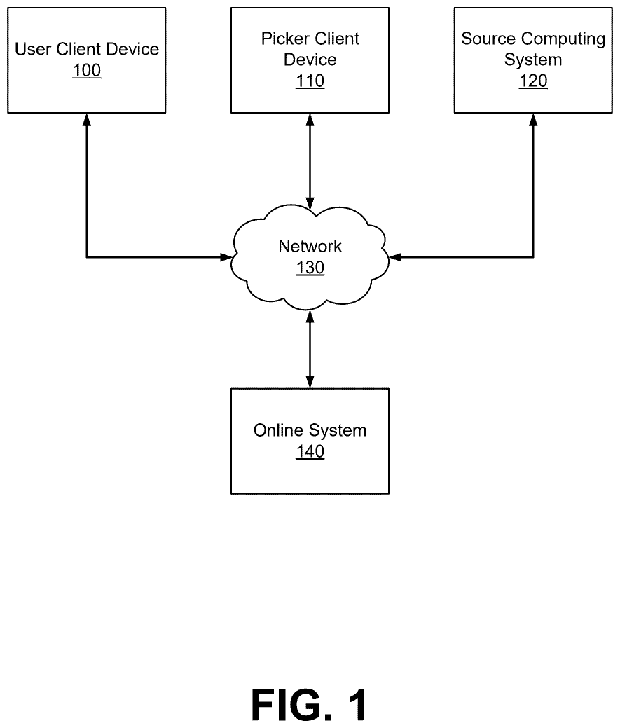

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online system 140. In various embodiments, the user client device 100 may monitor the contents of a storage area (e.g., a food storage area) associated with the user. For example, the user client device 100 may be a smart refrigerator or a smart pantry system that identifies the items within it. The user client device 100 may identify items in the storage area in various ways. In some embodiments, the user client device 100 includes various components (e.g., cameras, barcode readers, radio frequency identification (RFID) scanners, sensors, etc.) that it uses to capture various types of data associated with items in the storage area (e.g., image or video data of the items, data identifying the items encoded in barcodes or RFID tags included on packaging for the items, etc.). In such embodiments, the user client device 100 may then identify the items based on the data captured by one or more of the components directly or by transmitting the data to the online system 140, which may then identify the items. For example, the user client device 100 or the online system 140 may identify items depicted in images or videos using one or more object detection techniques. Furthermore, in some embodiments, the user client device 100 also keeps track of usage of each item or a shelf life of each item using one or more of the components described above. For example, the user client device 100 may track a shelf life of each item based on a date (e.g., an expiration date, a use-by date, a best-by date, a sell-by date, etc.) associated with the item, an appearance of the item, or any other suitable types of information indicating its perishability.

A user uses the user client device 100 to place an order with the online system 140. An order specifies a set of items to be delivered to the user. An “item,” as used herein, refers to a good or a product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more source locations from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source location. The picker client device 110 presents the items that are included in the user's order to the picker in a collection interface. The collection interface is a user interface that provides information to the picker identifying items to collect for a user's order and indicating the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may identify the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 provides instructions to a picker for delivering the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they may use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be a user client device 100 being operated by a user collecting items for themselves within the source location. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, a warehouse, or any other source location from which a picker may collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Furthermore, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

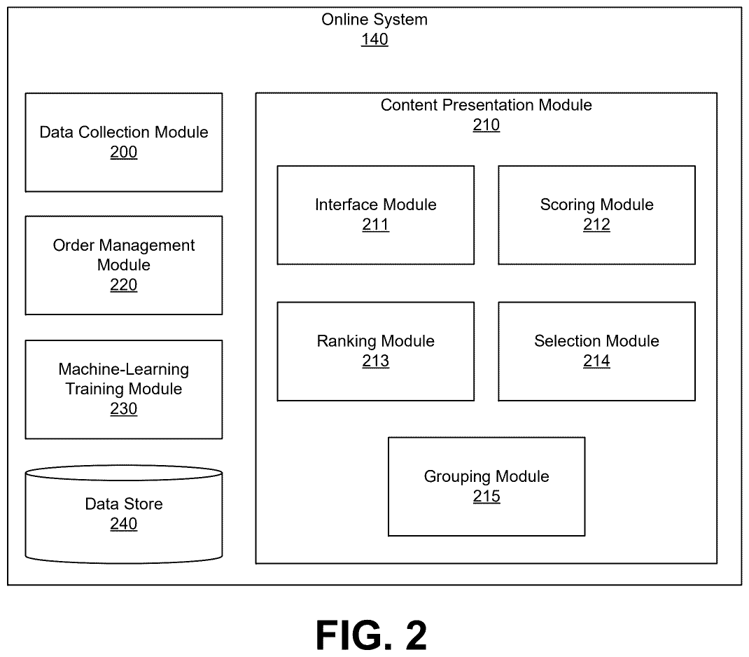

As an example, the online system 140 may allow a user to order groceries from a grocery store source. The user's order may specify which groceries they want to be delivered from the grocery store source and the quantities of each of the groceries. The user's client device 100 transmits the user's order to the online system 140 and the online system 140 selects a picker to travel to the grocery store source location to collect the groceries ordered by the user. The online system 140 transmits an offer to the picker for the picker to service the order in exchange for consideration and, if the picker accepts the offer, the picker collects the groceries from the grocery store source location. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user's name, address, preferences, (e.g., shopping or dietary preferences, preferred payment instruments, favorite items, sources, source locations, recipes, or cuisines, etc.), dietary restrictions, or stored payment instruments. User data also may include demographic information associated with a user (e.g., age, gender, geographical region, etc.) or household information associated with the user (e.g., a number of people in the user's household, whether the user's household includes children or pets, etc.). User data further may include a geographical location associated with a user. In some embodiments, user data also include attributes of a group of users in which a user is included, such as ordering habits associated with the group of users (e.g., a measure of similarity between items the group of users orders from sources and items the group of users orders from restaurants). In various embodiments, user data also include the contents of a storage area (e.g., a food storage area) associated with the user. User data may also include one or more scores (e.g., restaurant action scores, source action scores, or recipe action scores) associated with a user, as further described below. The user data also may include default settings established by the user, such as a default source/source location, payment instrument, delivery location, or delivery timeframe.

User data further may include information describing actions performed by a user. For example, user data may describe a type of each action performed by a user (e.g., searching for an item, adding an item to an ordering list, ordering an item, sharing or making a recipe, etc.), a time the user performed each action, a frequency with which the user performs each action, a time the user most recently performed each action, etc. An action performed by a user may be in a domain that is associated with one or more sources, one or more restaurants, one or more recipes, etc. For example, user data for a user may describe actions performed by the user in a first domain, such as placing orders from one or more sources, searching for or browsing items included among an inventory of each source, etc. In this example, user data for the user also may describe actions performed by the user in a second domain, such as placing orders from one or more restaurants, searching for or browsing items included among a menu of each restaurant, etc. In the above example, user data for the user also may describe actions performed by the user in a third domain, such as searching for or browsing recipes, saving one or more recipes, providing a rating for a recipe, sharing or preparing a recipe, etc. Information describing each action performed by a user may include item data, restaurant data, source data, recipe data, etc. associated with the action. For example, if a user viewed a recipe, user data for the user may include recipe data for the recipe.

User data also may include contextual information associated with a user. The contextual information may include a time of day, a day of the week, a holiday, a season, an event (e.g., the Super Bowl, a birthday, etc.), or a set of weather conditions (e.g., rain, hail, snow, etc.) associated with a current time or a current geographical location associated with the user. The contextual information further may include a set of items included in an ordering list associated with the user or an estimated delivery time for the set of items. For example, contextual information associated with a user may include information describing any delays in the delivery of items included in an ordering list associated with the user. Additionally, the contextual information may include an availability of a set of items for which the user searched or any other suitable types of contextual information. The data collection module 200 may collect the user data from sensors on the user client device 100 or based on the user's interactions with the online system 140. The data collection module 200 also may collect the user data from other components of the online system 140 or from any other suitable source.

The data collection module 200 also collects item data, which is information or data that identifies and describes items that are available at a source location or a restaurant. The item data may include item identifiers for items that are available and may include quantities of items associated with each item identifier. Additionally, item data may also include attributes of items such as the size (e.g., a portion size), color, weight, an item identifier (e.g., a name or a stock keeping unit (SKU)), serial number, price, item category, brand, quality (e.g., freshness, ripeness, etc.), ingredients/materials, manufacturing location, version/variety (e.g., flavor, low fat, gluten-free, organic, vegetarian, etc.) of an item. Attributes of items also may include the availability (predicted or actual), seasonality, nutritional information, rating, or any other suitable attributes of an item. Item data may also include images or videos of items, descriptions of items, or any other suitable types of information that may describe or identify items. Item data also may describe the perishability of items (e.g., based on a best by, use by, or sell by date for each item, a freshness or an appearance of each item, etc.). The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular source location), the item data may include a time that the item was last found, a time that the item was last not found (a picker looked for the item but could not find it), the rate at which the item is found, or the popularity of the item. The data collection module 200 may collect item data from a source computing system 120, a picker client device 110, or a user client device 100. The data collection module 200 also may collect item data from other components of the online system 140, a third-party system (e.g., a website that includes information describing the perishability of items, a website for a restaurant, etc.), or any other suitable source.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as apples, oranges, lettuce, and cucumbers may be included in a “produce” item category. As an additional example, items such as garlic bread, pasta, and alfredo sauce may be included in an “Italian cuisine” item category, while items such as soy sauce and kimchi may be included in an “Asian foods” item category. Furthermore, in various embodiments, an item may be included in multiple categories. For example, croissants may be included in a “croissant” item category, a “pastry” item category, and a “bakery” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a user rating for the picker, the source locations from which the picker has collected items, or the picker's previous shopping history. Additionally, the picker data may include preferences expressed by the picker, such as their preferred source locations for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in an order, a delivery location for the order, a user associated with the order, a source location or a restaurant from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data include user data for users associated with the order, such as user data for a user who placed the order or picker data for a picker who serviced the order. Order data also may include item data for items included in the order, such as information describing the perishability of the items (e.g., based on a best buy, use-by, or sell-by date for each item, a freshness or an appearance of each item, etc.).

Similarly, the data collection module 200 may collect purchase data, which is information or data describing characteristics of a purchase by a user who collected and purchased items for themselves from a source location or a restaurant. The purchase data may include item data for items included in purchases, user data for users associated with purchases, or any other suitable types of information. For example, purchase data for a purchase may include item data for items that are included in the purchase, user data for a user who made the purchase, and information describing the purchase (e.g., a source location or a restaurant from which the user purchased the items and a date and time of the purchase). Purchase data also may include item data for items included in a purchase, such as information describing the perishability of the items (e.g., based on a best buy, use-by, or sell-by date for each item, a freshness or an appearance of each item, etc.). The data collection module 200 may collect purchase data from sensors of the user client device 100 or from the user's interactions with the online system 140. The data collection module 200 also may collect purchase data from the source computing system 120, a third-party system (e.g., a website for a restaurant), or from any other suitable source.

The data collection module 200 also may collect recipe data, which is information or data describing characteristics of a recipe. Recipe data may include information that may be used to identify a recipe, such as a name of the recipe, a description of the recipe, an author of the recipe, a date the recipe was created, one or more images or videos associated with the recipe, etc. Recipe data also may include information describing a set of items associated with a recipe, such as information describing a set of ingredients of the recipe (e.g., information identifying each ingredient, an amount or a quantity of each ingredient, etc.) or information describing a set of tools used to prepare the recipe (e.g., aluminum foil, a rolling pin, a food processor, etc.). Recipe data also may include additional types of information, such as a set of instructions for preparing a recipe, an amount of time required to prepare the recipe, a set of nutritional information associated with the recipe, a difficulty level associated with preparing the recipe (e.g., easy, intermediate, or difficult), or a number of servings the recipe yields. Recipe data also may include information describing a cuisine associated with a recipe, a meal (e.g., brunch, dinner, dessert, etc.) associated with a recipe, or any other suitable types of information. The data collection module 200 may collect recipe data from a user client device 100, a third-party system (e.g., a website or an application), or any other suitable source.

Furthermore, the data collection module 200 may collect source data, which is information or data identifying and describing characteristics of a source. Source data may include a name of a source and information describing one or more source locations operated by the source, such as a geographical location and hours of operation of each source location. Source data also may include information describing types of items available at a source (e.g., groceries, clothing, housewares, etc.) or a type of the source (e.g., convenience, specialty, discount, high end, warehouse, etc.). Source data further may include item data for items included among an inventory of one or more source locations operated by a source. The data collection module 200 may collect source data from the source computing system 120 or any other suitable source.

Additionally, the data collection module 200 may collect restaurant data, which is information or data identifying and describing characteristics of a restaurant. Restaurant data may include information identifying a restaurant, such as a name and an address of the restaurant, and information describing the restaurant, such as hours of operation for the restaurant, a type of cuisine associated with the restaurant, and information included in a menu for the restaurant. Restaurant data also may indicate whether a restaurant caters or offers items for large groups (e.g., parties). Additionally, restaurant data may indicate whether a restaurant offers items that are consistent with a dietary restriction (e.g., vegetarian, vegan, keto, etc.). Restaurant data further may include item data for items included in a menu for a restaurant, a user rating for the restaurant, reviews for the restaurant, a type of the restaurant (e.g., upscale, casual, fast food, etc.), or any other suitable types of information. The data collection module 200 may collect restaurant data from a third-party system (e.g., a website or an application for a restaurant) or any other suitable source.

The data collection module 200 also may derive or infer various types of information based on other data stored in the data store 240 and store the derived/inferred information in the data store 240 (e.g., in association with the data from which it was derived/inferred). For example, based on order data associated with a user, the data collection module 200 may derive a frequency with which the user places orders from restaurants each day of the week, during different times of the day, during different weather conditions, etc. In this example, based on the order data, the data collection module 200 similarly may derive a frequency with which the user places orders from sources each day of the week, during different times of the day, during different weather conditions, etc. In the above example, based on the order data, the data collection module 200 also may derive a frequency with which the user orders items associated with each item category, an average amount the user spends on items associated with each item category, etc. As an additional example, based on order data and purchase data associated with a user, the data collection module 200 may derive a frequency with which the user places orders or makes purchases including frozen food items associated with certain cuisines and a frequency with which the user places orders from restaurants associated with the same cuisines. In some embodiments, the data collection module 200 also may derive or infer various types of information based on a set of rules. For example, based on a rule that a user is likely having a party if they have added at least three items included in a “party supply” item category (e.g., paper plates, napkins, plastic utensils, candles, etc.) to an ordering list for a source, the data collection module 200 may infer that a user is likely having a party if they have added at least three of these items to the ordering list.

While user data, picker data, item data, order data, purchase data, recipe data, source data, and restaurant data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. Components of the content presentation module 210 include: an interface module 211, a scoring module 212, a ranking module 213, a selection module 214, and a grouping module 215, which are further described below.

The interface module 211 generates and transmits a user interface (e.g., an ordering interface) for a user to order items (e.g., from a source or a restaurant). The interface module 211 may do so in response to receiving a request from a user client device 100 associated with the user to access the user interface. The interface module 211 may generate the user interface by populating it with items that the user may select for adding to their order or with sources or restaurants from which the user may order items. In some embodiments, the interface module 211 presents a catalog of all items that are available to the user, which the user can browse to select items to order. Other components of the content presentation module 210 may identify items that the user is most likely to order and the interface module 211 may then present those items to the user. For example, the scoring module 212 may score items and the ranking module 213 may rank the items based on their scores. In this example, the selection module 214 may select items with scores that exceed some threshold (e.g., the top n items or the p percentile of items) and the interface module 211 then displays the selected items. In some embodiments, the user interface also includes additional types of content with which a user may interact. For example, the user interface may allow a user to search, browse, share, or save recipes. The user interface may be adapted based on the predicted user actions. For example, the layout or prominence of certain recommendations may be adjusted based on the predicted likelihood of the user engaging with them.

The user interface may also include a set of recommendations generated by the interface module 211. Each recommendation may be associated with a restaurant, a source, or a recipe being recommended and may include information describing the restaurant, source, or recipe. For example, a recommendation for a restaurant may include a name of the restaurant, a description of the restaurant (e.g., a cuisine associated with the restaurant, a user rating for the restaurant, etc.) and information describing one or more items included in a menu for the restaurant. Each recommendation may be presented in a presentation unit (e.g., a carousel). In the above example, the recommendation for the restaurant may be included among additional recommendations for additional restaurants in a scrollable carousel of recommended restaurants. Furthermore, a position of each recommendation within a presentation unit may be based on a score or a rank associated with each restaurant, source, or recipe being recommended, as described below. Continuing with the above example, a restaurant associated with a highest rank may be presented in a most prominent position of the carousel, a restaurant associated with a second-highest rank may be presented in a second-most prominent position of the carousel, etc. Similarly, a position of each presentation unit within the user interface may be based on a score or a rank associated with the presentation unit. For example, a carousel associated with a highest rank may be presented in a most prominent position of the user interface, a carousel associated with a second-highest rank may be presented in a second-most prominent position of the user interface, etc.

The scoring module 212 may use an item selection model to score items for presentation to a user. An item selection model is a machine-learning model that is trained to score items for a user based on item data for the items and user data for the user. For example, the item selection model may be trained to determine a likelihood that a user will order an item. In some embodiments, the item selection model uses item embeddings describing items and user embeddings describing users to score items. These item embeddings and user embeddings may be generated by separate machine-learning models and may be stored in the data store 240.

In some embodiments, the scoring module 212 scores items based on a search query received from the user client device 100. A search query is free text for a word or a set of words that indicate items of interest to the user. The scoring module 212 scores items based on a relatedness of the items to the search query. For example, the scoring module 212 may apply natural language processing (NLP) techniques to the text in the search query to generate a search query representation (e.g., an embedding) that represents characteristics of the search query. The scoring module 212 may use the search query representation to score candidate items for presentation to a user (e.g., by comparing a search query embedding to an item embedding).

In some embodiments, the scoring module 212 scores items based on a predicted availability of an item. The scoring module 212 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The scoring module 212 may apply a weight to the score for an item based on the predicted availability of the item. Alternatively, an item may be filtered out from presentation to a user by the selection module 214 based on whether the predicted availability of the item exceeds a threshold.

The scoring module 212 also may retrieve a set of user data for a user from the data store 240. As described above, the set of user data may include information describing a set of actions in a domain performed by the user and the domain may be associated with one or more sources, restaurants, or recipes. For example, the set of user data may include a set of order data for orders the user placed from various sources or restaurants within a threshold amount of time of a current time. In this example, the set of user data may include a set of item data for each item included in the orders, such as a set of attributes of each item, information describing a perishability of each item, etc., and an amount the user spent on each order. As also described above, the set of user data may include attributes of a group of users in which the user is included, such as ordering habits associated with the group of users (e.g., a measure of similarity between items the group of users orders from sources and items the group of users orders from restaurants). The set of user data also may include a set of contextual information (e.g., a time of day, holiday, weather conditions, etc.) associated with the user, a set of preferences associated with the user, dietary restrictions associated with the user, or demographic or household information associated with the user. Additionally, the set of user data may also include information describing the contents of a storage area (e.g., a food storage area) associated with the user or any other suitable types of user data for the user.

The scoring module 212 may retrieve additional types of data from the data store 240. In some embodiments, the scoring module 212 also retrieves a set of restaurant data for each of multiple restaurants within a threshold distance of a geographical location associated with a user, such as a type of cuisine associated with each restaurant, item data for items included in a menu for each restaurant, etc. In some embodiments, the scoring module 212 also retrieves a set of source data for each of multiple sources that operates a source location within the threshold distance of the geographical location associated with a user, such as item data for items included among an inventory of the source location operated by each source. The scoring module 212 also may retrieve a set of recipe data for each of a set of multiple recipes, such as a type of cuisine associated with each recipe, information describing a set of items (e.g., ingredients, tools, etc.) associated with each recipe, etc., or any other suitable types of data.

The scoring module 212 also may predict a restaurant action score indicating a likelihood of a set of actions in a domain performed by a user if presented with a recommendation associated with a restaurant, in which the domain is associated with one or more restaurants. The restaurant action score may correspond to a value (e.g., from zero to one) that is proportional to the likelihood. The scoring module 212 may predict the restaurant action score for a restaurant based on a set of user data for the user, a set of restaurant data for the restaurant, or any other suitable types of data it retrieves from the data store 240. As described above, the set of user data for the user may include information describing a set of actions in a domain performed by the user and the domain may be associated with one or more sources or recipes. Furthermore, the scoring module 212 may predict a restaurant action score for a restaurant using a restaurant action prediction model, which is a machine-learning model trained to predict a restaurant action score for a restaurant. To use the restaurant action prediction model, the scoring module 212 may access the model (e.g., from the data store 240) and apply the model to a set of inputs. The set of inputs may include various types of data described above (e.g., a set of user data for a user, a set of restaurant data for a restaurant, etc.). Once the scoring module 212 applies the restaurant action prediction model to the set of inputs, the scoring module 212 may receive an output from the model, which may include a value corresponding to a restaurant action score. In some embodiments, the restaurant action prediction model is trained by the machine-learning training module 230, as described below.

The scoring module 212 also may predict a source action score indicating a likelihood of a set of actions in a domain performed by a user if presented with a recommendation associated with a source, in which the domain is associated with one or more sources. The source action score may correspond to a value (e.g., from zero to one) that is proportional to the likelihood. The scoring module 212 may predict the source action score for a source based on a set of user data for a user, a set of source data for the source, or any other suitable types of data it retrieves from the data store 240. As described above, the set of user data for the user may include information describing a set of actions in a domain performed by the user and the domain may be associated with one or more restaurants or recipes. Furthermore, the scoring module 212 may predict a source action score for a source using a source action prediction model, which is a machine-learning model trained to predict a source action score for a source. To use the source action prediction model, the scoring module 212 may access the model (e.g., from the data store 240) and apply the model to a set of inputs. The set of inputs may include various types of data described above (e.g., a set of user data for a user, a set of source data for a source, etc.). Once the scoring module 212 applies the source action prediction model to the set of inputs, the scoring module 212 may receive an output from the model, which may include a value corresponding to a source action score. In some embodiments, the source action prediction model is trained by the machine-learning training module 230, as described below.

The scoring module 212 also may predict a recipe action score indicating a likelihood of a set of actions in a domain performed by a user if presented with a recommendation associated with a recipe, in which the domain is associated with one or more recipes. The recipe action score may correspond to a value (e.g., from zero to one) that is proportional to the likelihood. The scoring module 212 may predict the recipe action score for a recipe based on a set of user data for a user, a set of recipe data for the recipe, or any other suitable types of data it retrieves from the data store 240. As described above, the set of user data for the user may include information describing a set of actions in a domain performed by the user and the domain may be associated with one or more restaurants or sources. Furthermore, the scoring module 212 may predict a recipe action score for a recipe using a recipe action prediction model, which is a machine-learning model trained to predict a recipe action score for a recipe. To use the recipe action prediction model, the scoring module 212 may access the model (e.g., from the data store 240) and apply the model to a set of inputs. The set of inputs may include various types of data described above (e.g., a set of user data for a user, a set of recipe data for a recipe, etc.). Once the scoring module 212 applies the recipe action prediction model to the set of inputs, the scoring module 212 may receive an output from the model, which may include a value corresponding to a recipe action score. In some embodiments, the recipe action prediction model is trained by the machine-learning training module 230, as described below.

In some embodiments, the scoring module 212 computes scores associated with presentation units (e.g., carousels). The scoring module 212 may do so based on scores (e.g., restaurant action scores, source action scores, or recipe action scores) associated with restaurants, sources, or recipes included in each presentation unit. For example, the scoring module 212 may compute a score associated with a first carousel based on a restaurant action score associated with each restaurant included in the first carousel, such that the first carousel is associated with a score corresponding to a sum or an average of the restaurant action scores. In this example, the scoring module 212 also may compute a score associated with a second carousel based on a source action score associated with each source included in the second carousel, such that the second carousel is associated with a score corresponding to a sum or an average of the source action scores.

In addition to ranking items, as described above, the ranking module 213 also may rank restaurants, sources, or recipes. The ranking module 213 may do so based on scores (e.g., restaurant action scores, source action scores, or recipe action scores) associated with the restaurants, sources, or recipes. For example, the ranking module 213 may rank restaurants based on a restaurant action score associated with each restaurant, such that a highest ranked restaurant is associated with a highest restaurant action score, a second-highest ranked restaurant is associated with a second-highest restaurant action score, etc. In some embodiments, the ranking module 213 ranks restaurants, sources, or recipes in a unified ranking. In the above example, the ranking module 213 also may rank the restaurants with sources in a unified ranking based on a restaurant action score associated with each restaurant and a source action score associated with each source, such that a highest ranked restaurant/source is associated with a highest restaurant/source action score, a second-highest ranked restaurant/source is associated with a second-highest restaurant/source action score, etc.

In various embodiments, the ranking module 213 also ranks presentation units (e.g., carousels). The ranking module 213 may do so based on scores associated with the presentation units. For example, suppose that the scoring module 212 has computed a score associated with each of multiple carousels. In this example, the ranking module 213 may then rank the carousels based on a score associated with each carousel, such that a highest ranked carousel is associated with a highest score, a second-highest ranked carousel is associated with a second-highest score, etc.

In addition to selecting items, as described above, the selection module 214 also may select a set of restaurants, sources, or recipes to recommend to a user of the online system 140. The selection module 214 may do so based on scores (e.g., restaurant action scores, source action scores, or recipe action scores) associated with the restaurants, sources, or recipes or a ranking associated with each restaurant, source, or recipe. For example, the selection module 214 may select a set of restaurants with restaurant action scores that exceed some threshold (e.g., the top n restaurants or the p percentile of restaurants) to recommend to a user. In some embodiments, the selection module 214 may not select any restaurants, sources, or recipes to recommend to the user. In the above example, if none of the restaurants is associated with a restaurant action score that exceeds the threshold, the selection module 214 may not select any restaurants to recommend to the user. In various embodiments, the selection module 214 also selects the set of restaurants, sources, or recipes to recommend to the user based on additional factors, such as a popularity of the restaurants, sources, or recipes (e.g., in a geographical region associated with the user) or based on any other suitable criteria. For example, in addition to selecting three restaurants associated with the highest restaurant action scores for recommendation to a user, the selection module 214 also may select two restaurants to recommend to the user, in which the two restaurants are the most popular restaurants in a city associated with a delivery address associated with the user. In the above example, the popularity of the restaurants may be based on an ordering rate associated with each restaurant, a number of orders placed from each restaurant, a user rating for each restaurant, etc.

In various embodiments, the selection module 214 also selects a set of presentation units (e.g., carousels) to recommend to a user of the online system 140. The selection module 214 may do so based on scores associated with the presentation units or a ranking associated with each presentation unit. For example, the selection module 214 may select a set of carousels with scores that exceed some threshold (e.g., the top n carousels or the p percentile of carousels) to recommend to a user. In some embodiments, the selection module 214 may not select any presentation units to recommend to the user. In the above example, if none of the carousels is associated with a score that exceeds the threshold, the selection module 214 may not select any carousels to recommend to the user.

The grouping module 215 may identify groups of users of the online system 140. The grouping module 215 may do so based on user data for the users (e.g., information describing actions performed by the users), order or purchase data associated with the users, or any other suitable types of information. For example, the grouping module 215 may identify groups of users based on user data for the users, in which the user data include a set of actions in a first domain performed by the users and a set of actions in a second domain performed by the users, in which the first domain is associated with one or more sources and the second domain is associated with one or more restaurants. Each group of users identified by the grouping module 215 may share similar attributes, such as similar habits (e.g., for ordering items or preparing foods). In the above example, a first group of users may order items only from sources, a second group of users may order items only from restaurants, a third group of users may order items from restaurants only on weekends or holidays, a fourth group of users may order items associated with every item category from sources and restaurants, etc. As an additional example, each group of users identified by the grouping module 215 may be associated with a measure of similarity between items the group of users orders from sources, items the group of users orders from restaurants, and items the group of users prepares themselves. In this example, a first group of users may be equally likely to order items associated with all item categories from sources and restaurants as they are to prepare them. In the above example, a second group of users may only order items associated with a “pizza” item category and a “Chinese cuisine” item category from restaurants and order or purchase items associated with all other item categories from sources or prepare them from ingredients ordered or purchased from sources.

The order management module 220 manages orders for items from users. The order management module 220 receives orders from user client devices 100 and offers the orders to pickers for service based on picker data. For example, the order management module 220 offers an order to a picker based on the picker's location and the source location from which the ordered items are to be collected. The order management module 220 may also offer an order to a picker based on how many items are in the order, a vehicle operated by the picker, the delivery location, the picker's preferences for how far to travel to deliver an order, the picker's ratings by users, or how often the picker agrees to service an order.

In some embodiments, the order management module 220 determines when to offer an order to a picker based on a delivery timeframe requested by the user who placed the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions indicating how the picker may travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, order data, purchase data, recipe data, source data, or restaurant data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

In embodiments in which the scoring module 212 accesses and applies the restaurant action prediction model to predict a restaurant action score for a restaurant, the machine-learning training module 230 may train the restaurant action prediction model. The machine-learning training module 230 may train the restaurant action prediction model via supervised learning or using any other suitable technique or combination of techniques based on data stored in the data store 240 or any other suitable types of data. Furthermore, once trained, the machine-learning training module 230 may retrain the restaurant action prediction model. For example, to refine the predictions made by the restaurant action prediction model, the training dataset used to retrain the restaurant action prediction model may be updated regularly as information describing actions performed by users of the online system 140 is updated to include the responses of the users to being presented with recommendations associated with restaurants.

To illustrate an example of how the machine-learning training module 230 may train the restaurant action prediction model, suppose that the machine-learning training module 230 receives a set of training examples. In this example, the set of training examples may include attributes of each of multiple users of the online system 140, such as information describing a set of previous actions (e.g., ordering, searching, or browsing items) in a domain performed by each user and contextual information associated with the user. In the above example, the domain may be associated with one or more sources. Alternatively, in the above example, the domain may be associated with one or more recipes. In this example, the attributes may also include item data, source data, recipe data, etc. associated with each action or household or demographic information, preferences, etc. associated with each user. In this example, the set of training examples also may include attributes of each of multiple restaurants, such as a cuisine, a rating, etc. associated with each restaurant. In the above example, the set of training examples may also include a label which represents an expected output of the restaurant action prediction model. In this example, the label may indicate, for each recommendation associated with a restaurant presented to each user, whether the user performed an action (e.g., placing an order) in an additional domain when presented with the recommendation, in which the additional domain is associated with one or more restaurants. Continuing with this example, the machine-learning training module 230 may then update a set of parameters of the restaurant action prediction model based on the sets of attributes, as well as the labels by comparing its output from input data of each training example to the label for the training example.

In embodiments in which the scoring module 212 accesses and applies the source action prediction model to predict a source action score for a source, the machine-learning training module 230 may train the source action prediction model. The machine-learning training module 230 may train the source action prediction model via supervised learning or using any other suitable technique or combination of techniques based on data stored in the data store 240 or any other suitable types of data. Furthermore, once trained, the machine-learning training module 230 may retrain the source action prediction model. For example, to refine the predictions made by the source action prediction model, the training dataset used to retrain the source action prediction model may be updated regularly as information describing actions performed by users of the online system 140 is updated to include the responses of the users to being presented with recommendations associated with sources.

To illustrate an example of how the machine-learning training module 230 may train the source action prediction model, suppose that the machine-learning training module 230 receives a set of training examples. In this example, the set of training examples may include attributes of each of multiple users of the online system 140, such as information describing a set of previous actions (e.g., ordering, searching, or browsing items) in a domain performed by each user and contextual information associated with the user. In the above example, the domain may be associated with one or more restaurants. Alternatively, in the above example, the domain may be associated with one or more recipes. In this example, the attributes may also include item data, restaurant data, recipe data, etc. associated with each action or household or demographic information, preferences, etc. associated with each user. In this example, the set of training examples also may include attributes of each of multiple sources, such as types of items (e.g., groceries, clothing, housewares, etc.) available at each source, a type (e.g., convenience, specialty, discount, high end, warehouse, etc.) of each source, item data for items included among an inventory of one or more source locations operated by each source, etc. In the above example, the set of training examples may also include a label which represents an expected output of the source action prediction model. In this example, the label may indicate, for each recommendation associated with a source presented to each user, whether the user performed an action (e.g., placing an order) in an additional domain when presented with the recommendation, in which the additional domain is associated with one or more sources. Continuing with this example, the machine-learning training module 230 may then update a set of parameters of the source action prediction model based on the sets of attributes, as well as the labels by comparing its output from input data of each training example to the label for the training example.

In embodiments in which the scoring module 212 accesses and applies the recipe action prediction model to predict a recipe action score for a recipe, the machine-learning training module 230 may train the recipe action prediction model. The machine-learning training module 230 may train the recipe action prediction model via supervised learning or using any other suitable technique or combination of techniques based on data stored in the data store 240 or any other suitable types of data. Furthermore, once trained, the machine-learning training module 230 may retrain the recipe action prediction model. For example, to refine the predictions made by the recipe action prediction model, the training dataset used to retrain the recipe action prediction model may be updated regularly as information describing actions performed by users of the online system 140 is updated to include the responses of the users to being presented with recommendations associated with recipes.

To illustrate an example of how the machine-learning training module 230 may train the recipe action prediction model, suppose that the machine-learning training module 230 receives a set of training examples. In this example, the set of training examples may include attributes of each of multiple users of the online system 140, such as information describing a set of previous actions (e.g., ordering, searching, or browsing items) in a domain performed by each user and contextual information associated with the user. In the above example, the domain may be associated with one or more restaurants. Alternatively, in the above example, the domain may be associated with one or more sources. In this example, the attributes may also include item data, restaurant data, source data, etc. associated with each action or household or demographic information, preferences, etc. associated with each user. In this example, the set of training examples may also include attributes of each of multiple recipes, such as a cuisine, a rating, ingredients, a difficulty level, etc. associated with each recipe. In the above example, the set of training examples also may include a label which represents an expected output of the recipe action prediction model. In this example, the label may indicate, for each recommendation associated with a recipe presented to each user, whether the user performed an action (e.g., saving or sharing a recipe) in an additional domain when presented with the recommendation, in which the additional domain is associated with one or more recipes. Continuing with this example, the machine-learning training module 230 may then update a set of parameters of the recipe action prediction model based on the sets of attributes, as well as the labels by comparing its output from input data of each training example to the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 retrains the machine-learning model using the additional training data, using any of the methods described above. This deployment and retraining process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, purchase data, picker data, recipe data, source data, and restaurant data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

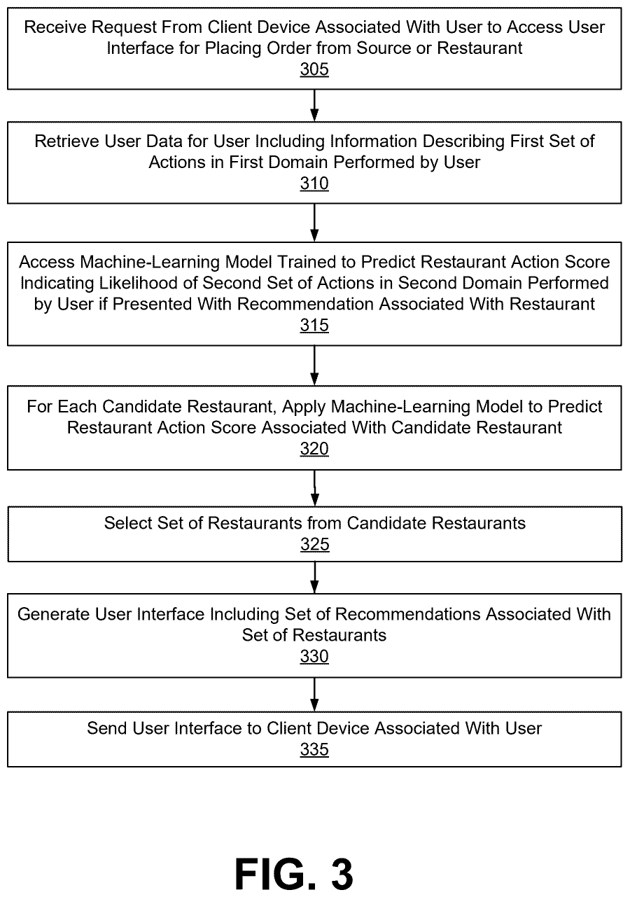

FIG. 3 is a flowchart for a method of predicting user actions in a domain based on user actions in another domain using machine learning, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

In some embodiments, the online system 140 identifies (e.g., using the grouping module 215) groups of users of the online system 140. The online system 140 may do so based on user data for the users (e.g., information describing actions performed by the users), order or purchase data associated with the users, or any other suitable types of information. Each group of users identified by the online system 140 may share similar attributes, such as similar habits (e.g., for ordering items or preparing foods). For example, each group of users identified by the online system 140 may be associated with a measure of similarity between items the group of users orders from sources, items the group of users orders from restaurants, and items the group of users prepares themselves. In this example, a first group of users may be equally likely to order items associated with all item categories from sources and restaurants as they are to prepare them. In the above example, a second group of users may only order items associated with a “pizza” item category and a “Chinese cuisine” item category from restaurants and order or purchase items associated with all other item categories from sources or prepare them from ingredients ordered or purchased from sources.

The online system 140 then receives 305 (e.g., via the interface module 211) a request from a user client device 100 associated with a user to access a user interface. The user interface may be an ordering interface that allows the user to place an order by selecting sources or restaurants from which the user may order items. In some embodiments, the user interface also includes additional types of content (e.g., recipes) with which a user may interact.

The online system 140 retrieves 310 (e.g., using the scoring module 212) a set of user data for the user (e.g., from the data store 240). The set of user data may include information describing a set of actions in a first domain performed by the user and the first domain may be associated with one or more sources. Alternatively, the set of user data may include information describing a set of actions in a second domain performed by the user and the second domain may be associated with one or more restaurants. As another alternative, the set of user data may include information describing a set of actions in a third domain performed by the user and the third domain may be associated with one or more recipes. In embodiments in which the online system 140 identifies groups of users of the online system 140, the set of user data may include attributes of a group of users in which the user is included, such as ordering habits associated with the group of users (e.g., a measure of similarity between items the group of users orders from sources and items the group of users orders from restaurants). The set of user data also may include a set of contextual information (e.g., a time of day, holiday, weather conditions, etc.) associated with the user, a set of preferences associated with the user, dietary restrictions associated with the user, or demographic or household information associated with the user. Additionally, the set of user data may also include information describing the contents of a storage area (e.g., a food storage area) associated with the user or any other suitable types of user data for the user.

The online system 140 also may retrieve (e.g., using the scoring module 212) additional types of data (e.g., from the data store 240). Examples of such types of data include a set of restaurant data for each of multiple candidate restaurants within a threshold distance of a geographical location associated with the user or a set of source data for each of multiple candidate sources that operates a source location within the threshold distance of the geographical location associated with the user. Additional examples of such types of data include a set of recipe data for each of multiple candidate recipes associated with the online system 140 or any other suitable types of data.

For each candidate restaurant of the multiple candidate restaurants, the online system 140 may predict (e.g., using the scoring module 212) a restaurant action score indicating a likelihood of a set of actions in the second domain performed by the user if presented with a recommendation associated with the candidate restaurant. As described above, the second domain may be associated with one or more restaurants. The restaurant action score may correspond to a value (e.g., from zero to one) that is proportional to the likelihood. The online system 140 may predict the restaurant action score for the candidate restaurant based on the set of user data for the user, a set of restaurant data for the candidate restaurant, or any other suitable types of data it retrieves (e.g., from the data store 240). As described above, the set of user data may describe a set of actions in the first domain performed by the user and the first domain may be associated with one or more sources or it may describe a set of actions in the third domain performed by the user and the third domain may be associated with one or more recipes.

The online system 140 may predict the restaurant action score for a candidate restaurant using a restaurant action prediction model, which is a machine-learning model trained to predict a restaurant action score for a restaurant. To use the restaurant action prediction model, the online system 140 may access 315 (e.g., using the scoring module 212) the model (e.g., from the data store 240) and apply 320 (e.g., using the scoring module 212) the model to a set of inputs. The set of inputs may include various types of data described above (e.g., the set of user data for the user, the set of restaurant data for the candidate restaurant, etc.). Once the online system 140 applies 320 the restaurant action prediction model to the set of inputs, the online system 140 may receive (e.g., via the scoring module 212) an output from the model, which may include a value corresponding to the restaurant action score. In some embodiments, the restaurant action prediction model is trained by the online system 140 (e.g., using the machine-learning training module 230).

The following illustrates an example of how the online system 140 may predict a restaurant action score indicating a likelihood of a set of actions in the second domain performed by the user if presented with a recommendation associated with a candidate restaurant, in which the set of actions corresponds to placing an order from the candidate restaurant and the candidate restaurant corresponds to a Greek restaurant. Suppose that attributes of a group of users in which the user is included indicate that the users often order items associated with a “Greek cuisine” item category from restaurants and sources. In this example, the restaurant action score may be proportional to an amount of time elapsed since the user last ordered items associated with the “Greek cuisine” item category or a number of items associated with the item category the user added to an ordering list for a source or for which the user searched during a current shopping session. In the above example, if the user added any items associated with the “Greek cuisine” item category to the ordering list, the restaurant action score also may be proportional to a length of any delay in the delivery of the items. Continuing with this example, the restaurant action score also may be inversely proportional to an availability of each item associated with the “Greek cuisine” item category for which the user searched and a number of items associated with the item category included in a food storage area associated with the user that has not reached the end of its shelf life. In the above example, if items associated with the “Greek cuisine” item category included in the food storage area are approaching the end of their shelf life and the user has not recently ordered more of the items, the restaurant action score may be proportional to a number of the items. In this example, the restaurant action score also may be affected by contextual information (e.g., time of day, day of the week, an event, weather conditions, etc.), preferences or dietary restrictions associated with the user, or other, non-intuitive factors that may affect the likelihood that the user will place an order from the Greek restaurant.

In embodiments in which the online system 140 retrieves a set of source data for each of multiple candidate sources, the online system 140 also or alternatively predicts (e.g., using the scoring module 212) a source action score for each candidate source. In such embodiments, the source action score indicates a likelihood of a set of actions in the first domain performed by the user if presented with a recommendation associated with the candidate source. The source action score may correspond to a value (e.g., from zero to one) that is proportional to the likelihood. The online system 140 may predict the source action score for the candidate source based on the set of user data for the user, a set of source data for the candidate source, or any other suitable types of data it retrieves (e.g., from the data store 240). As described above, the set of user data may describe a set of actions in the second domain performed by the user and the second domain may be associated with one or more restaurants or it may describe a set of actions in the third domain performed by the user and the third domain may be associated with one or more recipes.

The online system 140 may predict the source action score for a candidate source using a source action prediction model, which is a machine-learning model trained to predict a source action score for a source. To use the source action prediction model, the online system 140 may access (e.g., using the scoring module 212) the model (e.g., from the data store 240) and apply (e.g., using the scoring module 212) the model to a set of inputs. The set of inputs may include various types of data described above (e.g., the set of user data for the user, the set of source data for the candidate source, etc.). Once the online system 140 applies the source action prediction model to the set of inputs, the online system 140 may receive (e.g., via the scoring module 212) an output from the model, which may include a value corresponding to the source action score. In some embodiments, the source action prediction model is trained by the online system 140 (e.g., using the machine-learning training module 230).

In embodiments in which the online system 140 retrieves a set of recipe data for each of multiple candidate recipes, the online system 140 also or alternatively predicts (e.g., using the scoring module 212), a recipe action score for each candidate recipe. In such embodiments, the recipe action score indicates a likelihood of a set of actions in a third domain performed by the user if presented with a recommendation associated with the candidate recipe, in which the third domain is associated with one or more recipes. The recipe action score may correspond to a value (e.g., from zero to one) that is proportional to the likelihood. The online system 140 may predict the recipe action score for the candidate recipe based on the set of user data for the user, a set of recipe data for the candidate recipe, or any other suitable types of data it retrieves (e.g., from the data store 240). As described above, the set of user data may describe a set of actions in the first domain performed by the user and the first domain may be associated with one or more sources or it may describe a set of actions in the second domain performed by the user and the second domain may be associated with one or more restaurants.

The online system 140 may predict the recipe action score for a candidate recipe using a recipe action prediction model, which is a machine-learning model trained to predict a recipe action score for a recipe. To use the recipe action prediction model, the online system 140 may access (e.g., using the scoring module 212) the model (e.g., from the data store 240) and apply (e.g., using the scoring module 212) the model to a set of inputs. The set of inputs may include various types of data described above (e.g., the set of user data for the user, the set of recipe data for the candidate recipe, etc.). Once the online system 140 applies the recipe action prediction model to the set of inputs, the online system 140 may receive (e.g., via the scoring module 212) an output from the model, which may include a value corresponding to the recipe action score. In some embodiments, the recipe action prediction model is trained by the online system 140 (e.g., using the machine-learning training module 230).

The online system 140 may rank (e.g., using the ranking module 213) the candidate restaurants. The online system 140 may do so based on the restaurant action score associated with each candidate restaurant. For example, the ranking module 213 may rank restaurants based on a restaurant action score associated with each restaurant, such that a highest ranked restaurant is associated with a highest restaurant action score, a second-highest ranked restaurant is associated with a second-highest restaurant action score, etc. In embodiments in which the online system 140 also or alternatively predicts a source action score for each of multiple candidate sources or a recipe action score for each of multiple candidate recipes, the online system 140 may rank (e.g., using the ranking module 213) the candidate sources or recipes (e.g., in a unified ranking). In the above example, the online system 140 also may rank the candidate restaurants with candidate sources in a unified ranking based on a restaurant action score associated with each candidate restaurant and a source action score associated with each candidate source, such that a highest ranked candidate restaurant/source is associated with a highest restaurant/source action score, a second-highest ranked candidate restaurant/source is associated with a second-highest restaurant/source action score, etc.

The online system 140 may then select 325 (e.g., using the selection module 214) a set of restaurants from the candidate restaurants to recommend to the user. The online system 140 may do so based on the restaurant action scores associated with the candidate restaurants or a ranking associated with each candidate restaurant. In embodiments in which the online system 140 predicts a source action score for each of multiple candidate sources or a recipe action score for each of multiple candidate recipes, the online system 140 may select 325 a set of sources or recipes from the candidate sources or recipes. In such embodiments, the online system 140 may do so based on the source/recipe action scores associated with the candidate sources/recipes or a ranking associated with each candidate source/recipe. In some embodiments, the online system 140 may not select 325 any restaurants (or sources/recipes) to recommend to the user, as further described below. In various embodiments, the online system 140 also selects 325 the set of restaurants (or sources/recipes) to recommend to the user based on additional factors, such as a popularity of the restaurants (or sources/recipes, e.g., in a geographical region associated with the user) or based on any other suitable criteria.

Once the online system 140 selects 325 the set of restaurants (or sources/recipes), the online system 140 generates 330 (e.g., using the interface module 211) the user interface including a set of recommendations associated with the set of restaurants (or sources/recipes) and sends 335 (e.g., using the interface module 211) the user interface to the user client device 100 associated with the user, causing the user client device 100 to display the user interface. Each recommendation may be associated with a restaurant (or a source or a recipe) being recommended and may include information describing the restaurant (or source/recipe). Additionally, each recommendation may be presented in a presentation unit (e.g., a carousel). Furthermore, a position of each recommendation within a presentation unit may be based on a score or a rank associated with each restaurant (or each source/recipe) being recommended.

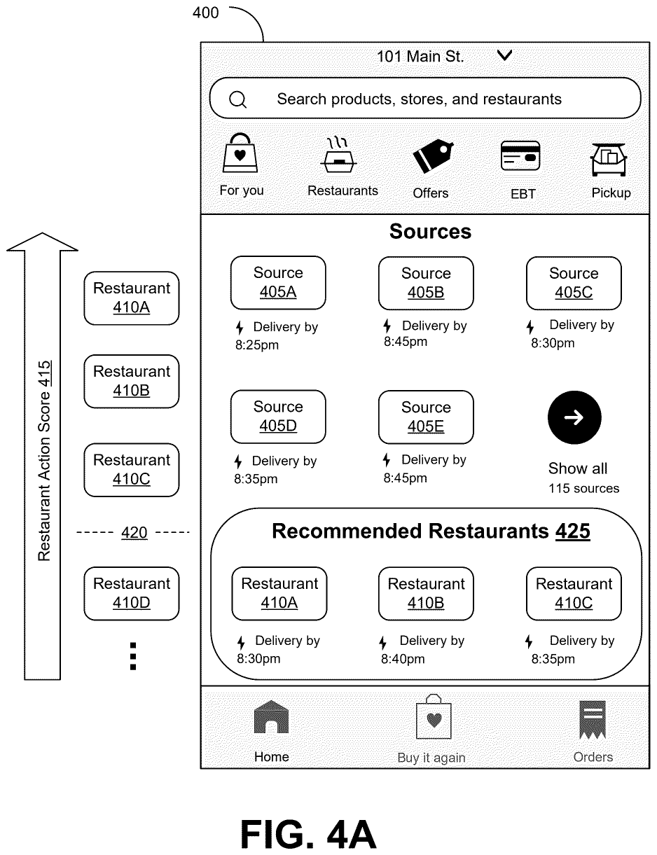

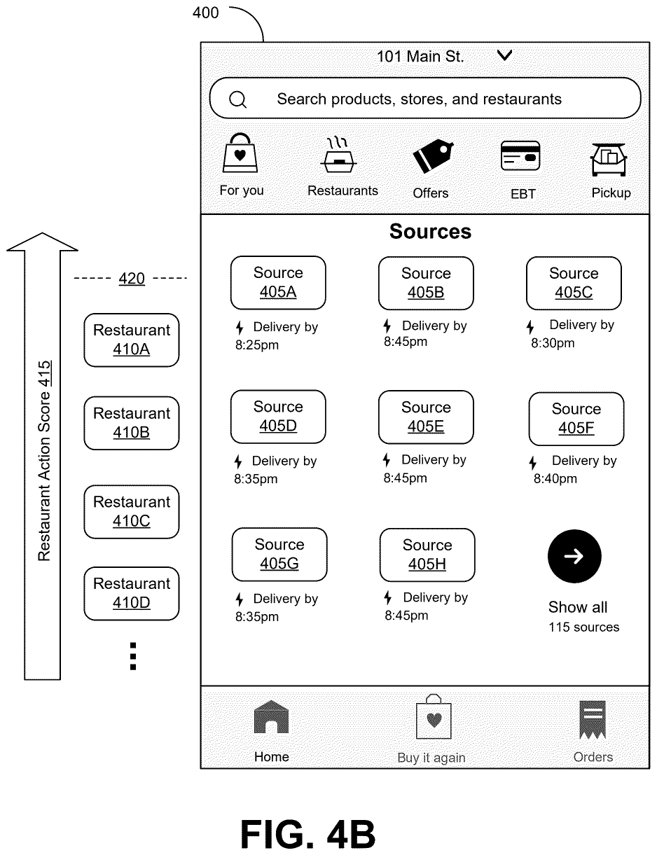

FIGS. 4A-4B illustrate examples of a user interface 400 including a set of recommendations associated with a set of restaurants 410 selected based on a restaurant action score 415, in accordance with one or more embodiments. Referring first to FIG. 4A, suppose that the online system 140 selects 325 three restaurants 410A-C with restaurant action scores 415 that exceed some threshold 420. In this example, the online system 140 then generates 330 the user interface 400 including a carousel 425 of recommended restaurants 410A-C that includes a recommendation for each selected restaurant 410A-C. In this example, the restaurant 410A associated with a highest restaurant action score 415 may be presented in a most prominent position of the carousel 425, the restaurant 410B associated with a second-highest restaurant action score 415 may be presented in a second-most prominent position of the carousel 425, etc. As shown in FIG. 4B, suppose instead that none of the restaurants 410 is associated with a restaurant action score 415 that exceeds the threshold 420. In this example, the online system 140 may not select 325 any restaurants 410 to recommend to the user, such that the user interface 400 does not include recommendations for any restaurants 410 and only includes sources 405.

In various embodiments, prior to generating 330 the user interface 400, the online system 140 computes (e.g., using the scoring module 212) scores associated with candidate presentation units (e.g., candidate carousels 425). The online system 140 may do so based on scores (e.g., restaurant action scores 415, source action scores, or recipe action scores) associated with restaurants 410, sources 405, or recipes included in each candidate presentation unit (e.g., as a sum or an average of the scores). In such embodiments, the online system 140 may then rank (e.g., using the ranking module 213) the candidate presentation units based on the scores associated with each candidate presentation unit. The online system 140 may then select (e.g., using the selection module 214) a set of presentation units to recommend to the user based on the scores or a ranking associated with each candidate presentation unit. In some embodiments, the online system 140 may not select any presentation units to recommend to the user (e.g., if none of the presentation units is associated with a score that exceeds a threshold). Once the online system 140 selects a set of presentation units to recommend to the user, it may generate 330 the user interface 400 including the set of presentation units and send 335 the user interface 400 to the user client device 100 associated with the user, causing the user client device 100 to display the user interface 400. A position of each presentation unit within the user interface 400 may be based on a score or a rank associated with the presentation unit.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that are issued on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online system, a request from a client device associated with a user of the online system to access a user interface for placing an order from a source or a restaurant;
retrieving a set of user data for the user, the set of user data comprising information describing a first set of actions in a first domain performed by the user, wherein the first domain is associated with one or more sources;
accessing a machine-learning model trained to predict a restaurant action score indicating a likelihood of a second set of actions in a second domain being performed by the user if presented with a recommendation associated with a restaurant, wherein the second domain is associated with one or more restaurants and the machine-learning model is trained by:
gathering a set of training examples, each training example of the set of training examples comprising information describing: a set of previous actions in the first domain performed by each user of a plurality of users of the online system, a restaurant associated with each recommendation of one or more recommendations presented to each user of the plurality of users, and, for each recommendation of the one or more recommendations presented to each user of the plurality of users, whether a corresponding user performed one or more actions in the second domain when presented with a corresponding recommendation, and
updating a set of parameters of the machine-learning model based at least in part on the set of training examples;
for each candidate restaurant of a plurality of candidate restaurants associated with the online system, applying the machine-learning model to predict the restaurant action score associated with the candidate restaurant based at least in part on the set of user data for the user and a set of restaurant data for the candidate restaurant;
selecting a set of restaurants from the plurality of candidate restaurants based at least in part on the restaurant action score associated with each candidate restaurant of the plurality of candidate restaurants;
generating the user interface comprising a set of recommendations associated with the set of restaurants; and
sending the user interface to the client device associated with the user, causing the client device to display the user interface.

2. The method of claim 1, further comprising:
identifying a group of users that includes the user based at least in part on the set of user data for the user, wherein the set of user data further comprises a set of previous actions in the second domain performed by the user and the group of users is associated with a measure of similarity between items ordered by the group of users from sources and items the group of users orders from restaurants.

3. The method of claim 2, wherein retrieving the set of user data for the user comprises:
retrieving information describing the measure of similarity between items the group of users orders from sources and items the group of users orders from restaurants.

4. The method of claim 1, wherein selecting the set of restaurants from the plurality of candidate restaurants based at least in part on the restaurant action score associated with each candidate restaurant of the plurality of candidate restaurants comprises:
ranking the plurality of candidate restaurants based at least in part on the restaurant action score associated with each candidate restaurant of the plurality of candidate restaurants; and
selecting the set of restaurants from the plurality of candidate restaurants based at least in part on the ranking.

5. The method of claim 1, further comprising:
accessing an additional machine-learning model trained to predict a source action score indicating an additional likelihood of a set of actions in the first domain performed by the user if presented with a recommendation associated with a source, wherein the additional machine-learning model is trained by:
gathering an additional set of training examples, each training example of the additional set of training examples comprising information describing: a set of previous actions in the second domain performed by each user of an additional plurality of users of the online system, a source associated with each recommendation of an additional set of recommendations presented to each user of the additional plurality of users, and, for each recommendation of the additional set of recommendations presented to each user of the additional plurality of users, whether a corresponding user performed one or more actions in the first domain when presented with a corresponding recommendation, and
updating a set of parameters of the additional machine-learning model based at least in part on the additional set of training examples;
for each candidate source of a plurality of candidate sources associated with the online system, applying the additional machine-learning model to predict the source action score associated with the candidate source based at least in part on the set of user data for the user and a set of source data for the candidate source, wherein the set of user data for the user further comprises information describing an additional set of actions in the second domain performed by the user;
ranking the plurality of candidate restaurants and the plurality of candidate sources in a unified ranking based at least in part on the restaurant action score associated with each candidate restaurant of the plurality of candidate restaurants and the source action score associated with each candidate source of the plurality of candidate sources; and
selecting the set of restaurants from the plurality of candidate restaurants and a set of sources from the plurality of candidate sources based at least in part on the unified ranking.

6. The method of claim 5, wherein generating the user interface comprising the set of recommendations associated with the set of restaurants comprises:
including, in the user interface, an additional set of recommendations associated with the set of sources.

7. The method of claim 1, wherein generating the user interface comprising the set of recommendations associated with the set of restaurants comprises:
including, in the user interface, an additional set of restaurants, wherein each restaurant of the additional set of restaurants is associated with at least a threshold measure of popularity in a geographical region associated with the user, and the threshold measure of popularity is based at least in part on one or more of: an ordering rate, a number of orders, or a user rating.

8. The method of claim 1, wherein applying the machine-learning model to predict the restaurant action score associated with the candidate restaurant based at least in part on the set of user data for the user and the set of restaurant data for the candidate restaurant comprises:
applying the machine-learning model to predict the restaurant action score associated with the candidate restaurant based on a set of contextual information associated with the user, wherein the set of contextual information comprises one or more of: a time of a day, a day of a week, a holiday, a season, an event, a set of weather conditions, information describing a set of items the user added to an ordering list, an estimated delivery time for an order including a set of items the user added to the ordering list, or an availability of a set of items for which the user searched.

9. The method of claim 1, wherein applying the machine-learning model to predict the restaurant action score associated with the candidate restaurant based at least in part on the set of user data for the user and the set of restaurant data for the candidate restaurant comprises:
applying the machine-learning model to predict the restaurant action score associated with the candidate restaurant based on order data for a set of orders the user placed within a threshold amount of time of a current time, wherein the order data comprises one or more of: an attribute associated with each item included in the set of orders, a perishability of each item included in the set of orders, or an amount spent on each order of the set of orders.

10. The method of claim 1, further comprising:
receiving information indicating whether the user performed the second set of actions in the second domain when presented with the user interface comprising the set of recommendations associated with the set of restaurants; and
retraining the machine-learning model based at least in part on whether the user performed the second set of actions in the second domain when presented with the user interface comprising the set of recommendations associated with the set of restaurants and information describing the set of restaurants.

11. A computer program product comprising a non-transitory computer-readable storage medium having instructions encoded thereon that, when executed by a processor, cause the processor to perform steps comprising:
receiving, at an online system, a request from a client device associated with a user of the online system to access a user interface for placing an order from a source or a restaurant;
retrieving a set of user data for the user, the set of user data comprising information describing a first set of actions in a first domain performed by the user, wherein the first domain is associated with one or more sources;
accessing a machine-learning model trained to predict a restaurant action score indicating a likelihood of a second set of actions in a second domain performed by the user if presented with a recommendation associated with a restaurant, wherein the second domain is associated with one or more restaurants and the machine-learning model is trained by:
gathering a set of training examples, each training example of the set of training examples comprising information describing: a set of previous actions in the first domain performed by each user of a plurality of users of the online system, a restaurant associated with each recommendation of one or more recommendations presented to each user of the plurality of users, and, for each recommendation of the one or more recommendations presented to each user of the plurality of users, whether a corresponding user performed one or more actions in the second domain when presented with a corresponding recommendation, and
updating a set of parameters of the machine-learning model based at least in part on the set of training examples;
for each candidate restaurant of a plurality of candidate restaurants associated with the online system, applying the machine-learning model to predict the restaurant action score associated with the candidate restaurant based at least in part on the set of user data for the user and a set of restaurant data for the candidate restaurant;
selecting a set of restaurants from the plurality of candidate restaurants based at least in part on the restaurant action score associated with each candidate restaurant of the plurality of candidate restaurants;
generating the user interface comprising a set of recommendations associated with the set of restaurants; and
sending the user interface to the client device associated with the user, causing the client device to display the user interface.

12. The computer program product of claim 11, wherein the computer-readable storage medium further has instructions encoded thereon that, when executed by the processor, cause the processor to perform steps comprising:
identifying a group of users that includes the user based at least in part on the set of user data for the user, wherein the set of user data further comprises a set of previous actions in the second domain performed by the user and the group of users is associated with a measure of similarity between items ordered by the group of users from sources and items the group of users orders from restaurants.

13. The computer program product of claim 12, wherein retrieving the set of user data for the user comprises:
retrieving information describing the measure of similarity between items the group of users orders from sources and items the group of users orders from restaurants.

14. The computer program product of claim 11, wherein selecting the set of restaurants from the plurality of candidate restaurants based at least in part on the restaurant action score associated with each candidate restaurant of the plurality of candidate restaurants comprises:
ranking the plurality of candidate restaurants based at least in part on the restaurant action score associated with each candidate restaurant of the plurality of candidate restaurants; and
selecting the set of restaurants from the plurality of candidate restaurants based at least in part on the ranking.

15. The computer program product of claim 11, wherein the computer-readable storage medium further has instructions encoded thereon that, when executed by the processor, cause the processor to perform steps comprising:
accessing an additional machine-learning model trained to predict a source action score indicating an additional likelihood of a set of actions in the first domain performed by the user if presented with a recommendation associated with a source, wherein the additional machine-learning model is trained by:
gathering an additional set of training examples, each training example of the additional set of training examples comprising information describing: a set of previous actions in the second domain performed by each user of an additional plurality of users of the online system, a source associated with each recommendation of an additional set of recommendations presented to each user of the additional plurality of users, and, for each recommendation of the additional set of recommendations presented to each user of the additional plurality of users, whether a corresponding user performed one or more actions in the first domain when presented with a corresponding recommendation, and
updating a set of parameters of the additional machine-learning model based at least in part on the additional set of training examples;
for each candidate source of a plurality of candidate sources associated with the online system, applying the additional machine-learning model to predict the source action score associated with the candidate source based at least in part on the set of user data for the user and a set of source data for the candidate source, wherein the set of user data for the user further comprises information describing an additional set of actions in the second domain performed by the user;
ranking the plurality of candidate restaurants and the plurality of candidate sources in a unified ranking based at least in part on the restaurant action score associated with each candidate restaurant of the plurality of candidate restaurants and the source action score associated with each candidate source of the plurality of candidate sources; and
selecting the set of restaurants from the plurality of candidate restaurants and a set of sources from the plurality of candidate sources based at least in part on the unified ranking.

16. The computer program product of claim 15, wherein generating the user interface comprising the set of recommendations associated with the set of restaurants comprises:
including, in the user interface, an additional set of recommendations associated with the set of sources.

17. The computer program product of claim 11, wherein generating the user interface comprising the set of recommendations associated with the set of restaurants comprises:
including, in the user interface, an additional set of restaurants, wherein each restaurant of the additional set of restaurants is associated with at least a threshold measure of popularity in a geographical region associated with the user, and the threshold measure of popularity is based at least in part on one or more of: an ordering rate, a number of orders, or a user rating.

18. The computer program product of claim 11, wherein applying the machine-learning model to predict the restaurant action score associated with the candidate restaurant based at least in part on the set of user data for the user and the set of restaurant data for the candidate restaurant comprises:
applying the machine-learning model to predict the restaurant action score associated with the candidate restaurant based on a set of contextual information associated with the user, wherein the set of contextual information comprises one or more of: a time of a day, a day of a week, a holiday, a season, an event, a set of weather conditions, information describing a set of items the user added to an ordering list, an estimated delivery time for an order including a set of items the user added to the ordering list, or an availability of a set of items for which the user searched.

19. The computer program product of claim 11, wherein applying the machine-learning model to predict the restaurant action score associated with the candidate restaurant based at least in part on the set of user data for the user and the set of restaurant data for the candidate restaurant comprises:
applying the machine-learning model to predict the restaurant action score associated with the candidate restaurant based on order data for a set of orders the user placed within a threshold amount of time of a current time, wherein the order data comprises one or more of: an attribute associated with each item included in the set of orders, a perishability of each item included in the set of orders, or an amount spent on each order of the set of orders.

20. A computer system comprising:
a processor; and
a non-transitory computer-readable storage medium storing instructions that, when executed by the processor, perform actions comprising:
receiving, at an online system, a request from a client device associated with a user of the online system to access a user interface for placing an order from a source or a restaurant;
retrieving a set of user data for the user, the set of user data comprising information describing a first set of actions in a first domain performed by the user, wherein the first domain is associated with one or more sources;
accessing a machine-learning model trained to predict a restaurant action score indicating a likelihood of a second set of actions in a second domain performed by the user if presented with a recommendation associated with a restaurant, wherein the second domain is associated with one or more restaurants and the machine-learning model is trained by:
gathering a set of training examples, each training example of the set of training examples comprising information describing: a set of previous actions in the first domain performed by each user of a plurality of users of the online system, a restaurant associated with each recommendation of one or more recommendations presented to each user of the plurality of users, and, for each recommendation of the one or more recommendations presented to each user of the plurality of users, whether a corresponding user performed one or more actions in the second domain when presented with a corresponding recommendation, and
updating a set of parameters of the machine-learning model based at least in part on the set of training examples;
for each candidate restaurant of a plurality of candidate restaurants associated with the online system, applying the machine-learning model to predict the restaurant action score associated with the candidate restaurant based at least in part on the set of user data for the user and a set of restaurant data for the candidate restaurant;
selecting a set of restaurants from the plurality of candidate restaurants based at least in part on the restaurant action score associated with each candidate restaurant of the plurality of candidate restaurants;
generating the user interface comprising a set of recommendations associated with the set of restaurants; and
sending the user interface to the client device associated with the user, causing the client device to display the user interface.
